(19) United States
(12) Patent Application Publication
(10) Pub. No.: US 2008/0226111 A1
(43) Pub. Date: Sep. 18, 2008

(54) Headphone with components secured together by snapping

(76) Inventor: Ching-chi Wang, Chashan (CN)

Correspondence Address: SAM CHEN, 7F-1, 293, ROOSEVELT ROAD, SEC 3, TAIPEI, TW

(21) Appl. No.: 11/684,641

(22) Filed: Mar. 12, 2007

(51) Int. Cl. H04R 25/00

(52) U.S. Cl. 381/375

(57) ABSTRACT

A headphone is disclosed that includes left and right receivers each including an outer housing, an inner housing secured to the outer housing by snapping, a first disk, a second disk, a speaker, and a clapper wherein the first and second disks are mounted in a space formed by the inner and the outer housings, and the speaker and the clapper are mounted in a space formed by the inner housing and the second disk; a swivel microphone secured to an outer surface of either receiver by snapping; and a band having both ends secured to the left and right receivers by snapping. It is possible of quickly fastening or unfastening components of the headphone.

### BACKGROUND OF THE INVENTION

1. Field of Invention

The invention relates to headphones and more particularly to such a headphone having components adapted to secure together by snapping rather than by threaded fasteners.

2. Description of Related Art

Headphones are well known devices. Recently, a headphone can be attached to an MP3 player or iPod. One type of headphone is earbud which is a small headphone that is placed directly outside of the ear canal. However, a sufficiently high volume level made by using an earbud can cause temporary or permanent hearing impairment or deafness due to an effect called “masking.”

Another type of headphone is a relatively large headphone having a band or bands over the top of the head. Typically, components of this type of headphone are threadedly secured together. It is understood that fastening or unfastening threaded fasteners (e.g., screws or bolt and nut combinations) is a time consuming process. Further, threaded fasteners may get rusted due to accummulation of moisture as time evolves.

Still, there have been numerous suggestions in prior patents for headphone. For example, U.S. Pat. No. 6,252,970 discloses a headphone. Thus, continuing improvements in the exploitation of headphone are constantly being sought.

### SUMMARY OF THE INVENTION

It is therefore one object of the invention to provide a headphone having components adapted to secure together by snapping so that a fastening or an unfastening thereof is made easy and quick.

The above and other objects, features and advantages of the invention will become apparent from the following detailed description taken with the accompanying drawings.

### BRIEF DESCRIPTION OF THE DRAWINGS

FIG. 1 is an exploded view of a preferred embodiment of headphone according to the invention;

FIG. 2 is a perspective view of the assembled headphone;

FIG. 3 is a sectional view of FIG. 2; and

FIG. 4 is a perspective view of the microphone.

### DETAILED DESCRIPTION OF THE INVENTION

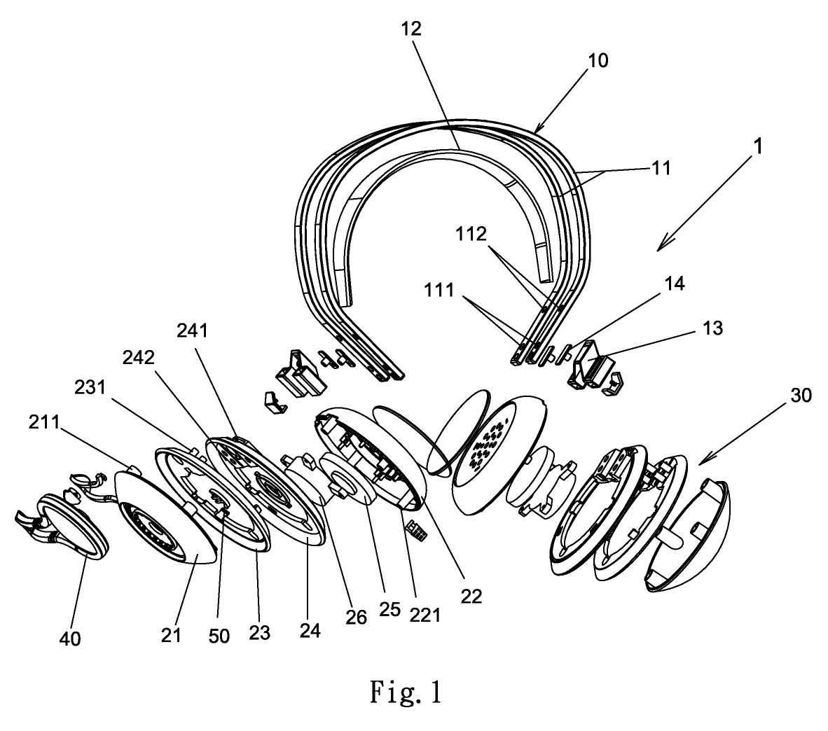

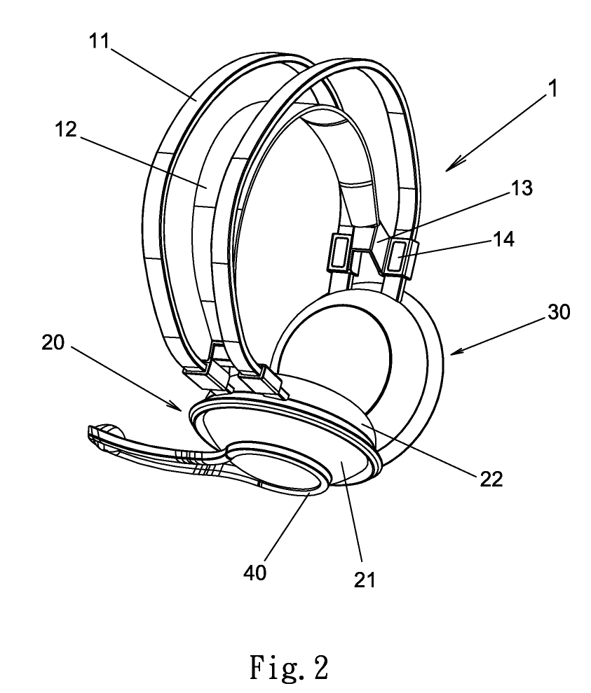

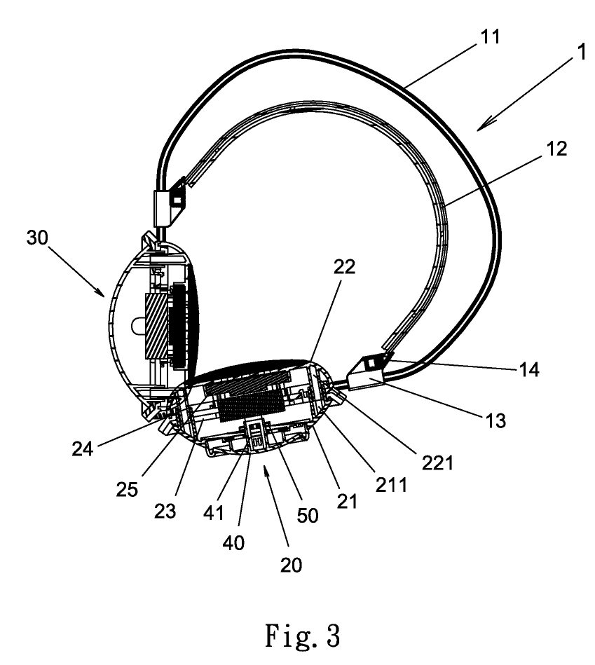

Referring to FIGS. 1 to 4, a headphone 1 in accordance with a preferred embodiment of the invention comprises a band 10, a left receiver 20, and a right receiver 30. Each component is discussed in detailed below.

The band 10 is adapted to put over a user's head and comprises two spaced, first curved members 11 each having two first holes 111 at either end and a second hole 112 spaced from the first hole 111 by a predetermined distance; a second curved member 12 shorter than the first curved member 11 and disposed between the first curved members 11; two connectors 13 each connecting the first curved members 11 and the second curved member 12 together; and two pairs of fasteners 14, each fastener 14 adapted to fasten the connector 13 and the first curved member 11 together by inserting through the connector 13 into the second hole 112.

A microphone 40 is joined to an outer portion of the left receiver 20 by means of a swivel connection (not numbered). The left receiver 20 comprises a disk-shaped, concave outer housing 21 having a plurality of holed projections 211 spaced around a periphery; a disk-shaped, concave inner housing 22 having a plurality of pegs 221 spaced around a periphery, the pegs 221 adapted to snugly insert into the holed projections 211 for fastening the inner and outer housing 21 and 22 together; a first disk 23 having a raised periphery proximate the outer housing 21; a second disk 24 having a raised periphery proximate the inner housing 22; a speaker 25; and a clapper 26 in which both the speaker 25 and the clapper 26 are mounted between the inner housing 22 and the second disk 24.

The second disk 24 comprises two spaced receptacles 241 on an upper portion, and two pairs of through holes 242 each transversely passing the receptacle 241. The first disk 23 has two pairs of studs 231 on an upper portion, the studs 231 adapted to insert through the through holes 242 and the receptacles 241 into the first holes 111 for securely engaging the left receiver 20 and the curved members 11 and 12 together, i.e., securing the left receiver 20 and the band 10 together.

Note that the right receiver 30 is generally identical to the left receiver 20 described above except it is a mirror image thereof. Accordingly, further description is omitted for purposes of brevity and convenience only, and is not limiting.

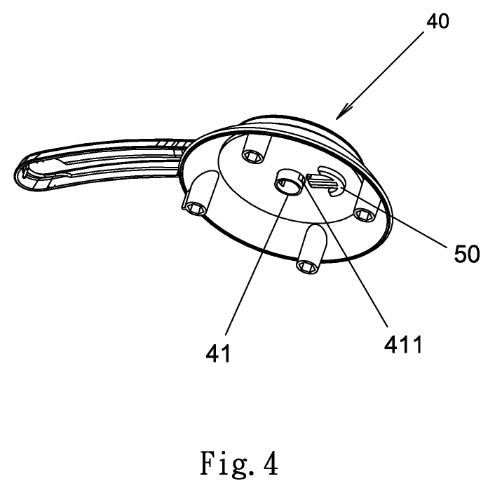

As shown in FIG. 4, a concave, disk-shaped housing of the microphone 40 comprises on its inner surface a central, hollow cylinder 41 having two opposite holes 411. The cylinder 41 is inserted into a central opening (not numbered) of the outer housing 21 to secure the microphone 40 and the left receiver 20 together by slidably inserting a pin 50 mounted on an outer surface of the first disk 23 into the holes 411.

While the invention herein disclosed has been described by means of specific embodiments, numerous modifications and variations could be made thereto by those skilled in the art without departing from the scope and spirit of the invention set forth in the claims.

What is claimed is:

1. A headphone comprising:
left and right receivers each including an outer housing, an inner housing secured to the outer housing by snapping, a first disk, a second disk, a speaker, and a clapper wherein the first and second disks are mounted in a space formed by the inner and the outer housings, and the speaker and the clapper are mounted in a space formed by the inner housing and the second disk;
a swivel microphone secured to an outer surface of either receiver by snapping; and
a band having both ends secured to the left and right receivers by snapping.

2. The headphone of claim 1, wherein the band comprises:
two spaced, first curved members each having two first holes at either end and a second hole spaced from the first hole by a predetermined distance;
a second curved member shorter than the first curved member and disposed between the first curved members;
two connectors each connecting the first curved members and the second curved member together; and
a plurality of fasteners each adapted to fasten the connector and the first curved member together by inserting through the connector into the second hole.

3. The headphone of claim 2, wherein the second disk comprises two spaced receptacles on an upper portion, and two pairs of through holes each transversely passing the receptacle; and the first disk comprises two pairs of studs on an upper portion, the studs adapted to insert through the through holes into the first holes for securely engaging either receiver and the first and the second curved members together.

4. The headphone of claim 1, wherein the outer housing comprises a plurality of holed projections spaced around a periphery, and the inner housing comprises a plurality of pegs spaced around a periphery, the pegs adapted to insert into the holed projections for fastening the inner and the outer housing together.
